(19) United States
(12) Patent Application Publication
(10) Pub. No.: US 2012/0171384 A1
(43) Pub. Date: Jul. 5, 2012

(54) SIZING AGENT FOR PAPER

(75) Inventors: Gunnar Kramer, Schifferstadt (DE); Josef Bung, Dannstadt-Schauernheim (DE)

(73) Assignee: BK GIULINI GMBH, Ludwigshafen (DE)

(21) Appl. No.: 13/386,992

(22) PCT Filed: Jul. 17, 2010
(86) PCT No.: PCT/EP2010/004372

§ 371 Date: Feb. 27, 2012

(30) Foreign Application Priority Data
Aug. 6, 2009 (DE) 10 2009 036 344.0

(51) Int. Cl. C09D 103/00; B05D 1/02

(52) U.S. Cl. 427/427.4; 524/47; 524/52

(57) ABSTRACT

The invention relates to a paste for surface sizing paper, containing an anionic optical brightener and a mixture comprising a cationic polymer dispersion and a cationic or amphoteric alkyl ketene dimer dispersion or emulsion as the sizing agent, and to the use thereof for surface sizing paper, and to the sizing method.

The present invention relates to a method for surface sizing paper, cardboard and paperboard.

Paper is a cellulose-containing fiber composite having a typical polar, strongly hydrophilic character, which is to say it can be easily wetted and swelled by aqueous systems. When writing on and imprinting paper, and also when processing paper, this results in excessive and uncontrolled penetration of water and other liquids (such as ink, printing inks) into the fibrous web. The resulting problems include weakening of the internal fiber bonding strength, worsening of the mechanical properties, decrease in the dimensional stability, and very poor writing and imprinting ability.

In order to control the wetting and penetration behavior so called sizing agents are employed, which through partial hydrophobization counteract the aforementioned behavior. These auxiliary agents can be added both to the aqueous cellulose pulp (internal sizing) or be applied by way of a surface treatment of the previously formed paper web using an appropriate application system such as a size press, film press, coater and the like (surface sizing). Both methods are employed together for some types of paper.

In surface sizing, typically an aqueous paste preparation is applied using the application system, which comprises a (decomposed) starch and a surface sizing agent and moreover contains further additives, such as polyvinyl alcohol, dyes, pigments, salts and optional brighteners. Common possible types of starches include, for example, potato starch, corn starch, wheat starch or tapioca starch, which can be pretreated prior to use by means of methods known to papermakers. These include oxidative, thermochemical or enzymatic decomposition methods, by means of which primarily the molecular weight and hence the viscosity are regulated. The starches can also be chemically modified, for example by cationization or alkylation.

According to the prior art, polymers are predominantly used as surface sizing agents, which can be present both in solution or in dispersed form (emulsion polymers). Common are, for example, modified copolymers of styrene and maleic acid anhydride, copolymers of methacrylate and acrylate monomers, copolymers of styrene comprising acrylate/methacrylate monomers, polyurethane dispersions or copolymers and graft polymers of acrylonitrile. All these sizing agents have in common that they contain a hydrophilic and a hydrophobic molecule section, wherein the hydrophilic part also defines the charge of the polymer. It is possible to employ anionic, amphoteric, cationic and in principle also non-ionogenic polymers. EP 406 461, EP 357 866, EP 735 065, EP 701 019 and EP 320 609 shall be mentioned by way of example.

From experience preferred fields of application exist for each type of surface sizing agent, with considerable differences existing in the effectiveness of individual products when applied to differing types of paper. The product selection can also be limited by the necessity to additionally use further auxiliary agents. The most important paper types for the production of which surface sizing agents can be employed are packaging papers and cardboards as well as graphic papers.

Typical packaging papers include, for example, kraft liners, test liners and corrugating medium or fluting, which are required to produce corrugated board packaging (base papers for corrugated boards). Fresh fibers (unbleached sulfate pulp), and preferably waste paper, are used as raw materials for production. The papers and cardboards can be gray, brown, or be provided with a light-colored cover layer (liner coated in white). A variety of other paper and cardboard types for a wide range of application purposes are used as additional packaging papers, such as shoe boxes, cigarette packs, confection boxes, fruit carriers, deep freezing packages, beverage cartons and fast food trays, just to name a few. The raw materials for producing these papers are likewise fresh fibers and waste papers, depending on the type. These cardboards can also be gray or white, are often coated on one side or both sides, and the surface is usually prepared for print purposes.

Graphic paper is the general term for types of paper that are used for writing and painting on and for imprinting. Typical examples include copy paper, offset paper, school exercise books, writing pads, calendars, post cards, watercolor paper, newspapers, magazine paper, advertising supplements, catalogs, book printing paper and many more. The raw materials used include mechanical pulp, thermomechanical pulp, reprocessed waste paper and others. Bleached pulp is used to a large extent. The papers and cardboards can be coated on one side or both sides and are predominantly white, but may also be gray or colored, for example. The white background is preferred so as to improve the entire appearance as well as the print and image contrast.

The “whiteness” is typically supported, and also subjectively increased, by using what is known as “optical brighteners”. These include in general disulfonic, tetrasulfonic or hexasulfonic acid derivatives of stilbene. These are used primarily in the surface, but also in wet areas. These brighteners all have an extremely high anionic charge, which is caused by the sulfonate groups on the molecule.

Cationic optical brighteners are also commercially available, however these are several times more expensive and therefore uneconomical for most applications.

In general, incompatibility, or at least negative mutual influencing, exists between anionic and cationic chemical compounds. The combination of the products results in the formation of coacervates, produces harmful precipitates, or the constituents interfere with or mutually eliminate their effectiveness. For this reason, according to the prior art only anionic, amphoteric or weakly cationic sizing agents can be used for surface sizing in combination with anionic optical brighteners. All of these are considerably less effective than more strongly cationic sizing agents.

The solution for the problems presented above is achieved by the present invention by conducting the surface sizing of paper using a special product combination, which surprisingly, for the first time, allows the use of a cationic sizing agent for the production of e. g. writing and printing papers in the presence of anionic optical brighteners, while preserving the considerably higher efficiency known of cationic sizing agents and without noticeable impairment of the brightener effect. This was made possible in an entirely unexpected manner by combining cationic polymer dispersions with cationic or amphoteric alkyl ketene dimer (AKD) dispersions as the surface sizing agents.

According to the invention, the cationic polymers dispersions known for surface sizing can be used as cationic polymer dispersions. The polymers are preferably emulsion polymers. Preferred monomers include ethylenically unsaturated compounds, for example styrene, and nitrogen-containing acrylate or methacrylate monomers, such as amine alkylated acrylamides and/or methacrylamides. Styrene acrylate copolymer dispersions are preferred. The acrylate used preferably includes acrylic acid esters such as methyl, ethyl, propyl and butyl acrylates, with butyl acrylate being particularly preferred, and more particularly tert. butyl acrylate. The copolymer further contains cationized acrylamide groups or methacryl amide groups, in particular dialkylaminoalkyl(meth)acrylamide groups. The alkyl amino groups are preferably methyl groups. The solids content typically ranges between 25 and 35%. The commercially available products Perglutin® K600, and more particularly Perglutin® K532, from BK Giulini GmbH, for example, are particularly suitable.

According to the invention, the typical alkyl ketene dimer dispersions and emulsions are suitable. These contain a lactone ring bearing long-chain alkyl radicals, preferably from fatty acids or fatty acid derivatives. The AKD dispersions available on the market primarily differ in terms of the fatty acids that are used in production, and hence in terms of the differing melting points and differentiated chain lengths and branches of the alkyl groups. A mixture comprising C16/C18 alkyl ketene dimers having a solidification point around approximately 40-50° C. is widely used. AKD melting at higher temperatures is produced based on higher fatty acids such as stearic acid (C18) or behenic acid (C22) and is employed in specialty papers or at higher pulp temperatures. The melting point of C18 AKD ranges between 55 and 60° C. and that of C22 AKD at approximately 58-65° C. Liquid AKD is produced based on oleic acid or isostearic acid. It has the advantage that no wax-like depositions are created and that it causes lower slidability on the paper surface because no migration of crystalline hydrolysis products takes place. The disadvantage of liquid AKD is a reduced sizing efficiency as compared to products containing linear alkyl groups. The solids content typically ranges from 10 to 25%. The dispersion or emulsion can also contain further additives such as dispersing agents and/or stabilizers in a way known as such. Cationic or amphoteric dispersing agents, for example cationic starch, polyamidoamine resins, polydiallyl dimethyl ammonium chloride are preferred. A possible stabilizer is notably starch.

Alkyl ketene dimer dispersions have been employed as internal sizing agents for quite some time in paper production. They have also been used already in surface sizing, where they are combined with amphoteric or weakly cationic polymers. Many experiments in which it was attempted to use them in pure form in the surface have failed, primarily because of difficult-to-control sizing, a long curing time until final sizing is reached, high slideability of the paper, deposits resulting from hydrolysis and other problems. Surprisingly, these negative properties of AKD can be considerably reduced with the use according to the invention, so that the supporting sizing action thereof can additionally be utilized.

According to the invention, a mixture is prepared from the cationic polymer dispersion and the AKD dispersion. The storage stability of the AKD is advantageously also considerably increased in the mixture. This was typically limited to 4 to 10 weeks and has improved to 8 to 14 weeks. The mixing ratio of the cationic polymer dispersion to the AKD dispersion, relative to the weight, is preferably from 90:10 to 50:50, more preferably from 85:15 to 70:30, and still more preferably approximately 80:20.

This mixture is added either in diluted or undiluted form as a sizing agent to the paste containing the anionic optical brightener. However, it is also possible to produce the mixture just before metering it into the application system. It is also possible to add the two products to the paste separately, however in this case the desired effect is generally far less.

In addition to the surface sizing agent, the paste according to the invention also contains starch and an anionic optical brightener and can contain further known additives. In particular polyvinyl alcohol, electrolytes, dyes and pigments should be mentioned here. The starch, and optionally the further additives, as well as the brightener are used in the known concentrations. It should be noted that the brightener does not significantly impair the sizing action of the surface sizing agent, even in very high concentrations.

In particular stilbene derivatives carrying sulfonic acid groups are suitable as anionic optical brighteners. Preferred are di-, tetra- or hexa-sulfonated stilbene derivatives, and still more preferred are di-, tetra- or hexa-sulfonated diamino stilbenes, such as 4,4′-diamino-2,2′-stilbene disulfonic acid, for example.

The method for surface sizing according to the invention is characterized by the use of an anionic optical brightener, together with a cationic polymer dispersion, as the sizing agent, which is possible by mixing the polymer dispersion with the alkyl ketene dimer dispersion or emulsion. The surface sizing is carried out otherwise in the known manner. The paste can be applied, for example, by spraying or by means of the known application systems such as a size press, film press, speed sizer, as well as online or offline using a coating system.

The invention will be described based on the following examples, however without being limited to the embodiments that are specifically described. Unless stated otherwise or unless the context automatically stipulates differently, the percentage information relates to the weight, in case of doubt to the total weight of the mixture. The invention also relates to all possible combinations of preferred embodiments, provided they do not mutually exclude each other. The expressions “approximately” or “about” in conjunction with numerical data shall mean that at least values that are higher or lower by 10%, or values that are higher or lower by 5%, and in any case values that are higher or lower by 1%, shall be included.

### EXAMPLE 1

A cationic polymer dispersion, trade name Perglutin K 532, was mixed with a cationic alkyl ketene dimer emulsion in various proportions to form a surface sizing agent. The following mixing ratios between the cationic polymer dispersion and AKD were adjusted:

a) 95:5, b) 90:10, c) 80:20 and d) 70:30.

Unsized raw paper having a grammage of 100 g/m², produced from 100% eucalyptus sulfate pulp and 15% precipitated calcium carbonate (PCC), was impregnated in a laboratory size press from the company Einlehner (Prüfmaschinenbau Augsburg) with a starch paste at 32 m/min and 3 bar contact pressure. The paste contained 7.5% of an enzymatically decomposed corn starch and the viscosity thereof was 33 mPas at 60° C. The pH value of the starch liquor without the added sizing agent was 6.6. Commercially available products, more specifically one from the group of tetra-sulfonated diamino stilbene derivatives and one from the group of hexa-sulfonated diamino stilbene derivatives, were used as optical brighteners in a very high concentration of 25 g/l. The sizing agent used in the paste was the cationic polymer dispersion in pure form and the mixtures with AKD a) to d) in a respective concentration of 7 g/l. After having been modified with the paste, the paper was dried for 2 minutes at 100° C. in a drum dryer and subsequently post-treated for 10 minutes at 105° C.

Then, the COBB value, wet absorption and brightness were determined. The COBB value is a measure of the water absorption of a paper. The lower the value, the better is the sizing. The COBB value is determined according to DIN 20535 (DIN EN 20535). The brightness was determined according to the standard DIN 53145/2 using an Elrepho 2000 from Datacolor. Wet absorption NA in [%] was calculated from the wet weight (m_{f}) and dry weight (mₗᵤₜᵣₒ) of the respective paper according to the formula

NA=(m_{f}−mₗᵤₜᵣₒ)/mₗᵤₜᵣₒ*100

where NA=wet absorption [%]
m_{f}=wet weight of the sample after the liquor pass [g]
mₗᵤₜᵣₒ=dry weight of the sample before the liquor pass [g].
Wet absorption for all papers was 54%.

The measured COBB values and brightness values are summarized in Tables 1 and 2:

TABLE 1

| | | ISO brightness |
|---|---|---|
| | Cobb_{60″post-cured} | D65/10° |
| Brightener Neucoblanc PSP = | 10 min/105° C. | R₄₅₇₊ |
| hexasulfo type | [g/m²] | [%] |
| Brightener only | 153 | 98.8 |
| Perglutin K 532 without AKD without | 73 | 79.2 |
| brightener | | |
| Perglutin K 532 without AKD with | 131 | 98.9 |
| brightener | | |
| Mixture a) without brightener | 75 | 80.7 |
| Mixture a) with brightener | 126 | 99.0 |
| Mixture b) without brightener | 63 | 80.4 |
| Mixture b) with brightener | 86 | 99.0 |
| Mixture c) without brightener | 47 | 80.3 |
| Mixture c) with brightener | 51 | 98.8 |
| Mixture d) without brightener | 28 | 80.2 |
| Mixture d) with brightener | 41 | 98.6 |

TABLE 2

| | | ISO brightness |
|---|---|---|
| | Cobb_{60″post-cured} | D65/10° |
| Brightener Neucoblanc PC 110 S = | 10 min/105° C. | R₄₅₇₊ |
| tetrasulfo type | [g/m²] | [%] |
| Brightener only | 149 | 100.3 |
| Perglutin K 532 without AKD without | 73 | 80.1 |
| brightener | | |
| Perglutin K 532 without AKD with | 128 | 98.9 |
| brightener | | |
| Mixture a) without brightener | 81 | 80.1 |
| Mixture a) with brightener | 124 | 99.9 |
| Mixture b) without brightener | 69 | 80.3 |
| Mixture b) with brightener | 84 | 100.5 |
| Mixture c) without brightener | 52 | 80.3 |
| Mixture c) with brightener | 53 | 100.1 |
| Mixture d) without brightener | 29 | 80.6 |
| Mixture d) with brightener | 38 | 98.8 |

It is apparent from the tables that the negative influence of the anionic brightener on the sizing action of the cationic polymer dispersion decreases significantly already when adding 10% AKD dispersion. No loss of brightness occurs.

### EXAMPLE 2

A cationic polymer dispersion, trade name Perglutin K 532, was mixed with a cationic alkyl ketene dimer emulsion at a ratio of 80:20 by stirring. This mixture according to the invention was compared to the cationic polymer dispersion Perglutin K 532, the anionic polymer dispersion Perglutin A 288, and the cationic promoter-free alkyl ketene dimer emulsion. For this purpose, unsized raw paper having a grammage of 100 g/m², produced from 100% eucalyptus sulfate pulp and 15% precipitated calcium carbonate (PCC), was impregnated in a laboratory size press from the company Einlehner (Prüfmaschinenbau Augsburg) with a starch paste at 32 m/min and 3 bar contact pressure. The paste contained 7.5% of an enzymatically decomposed corn starch and the viscosity thereof was 34 mPas at 60° C. The pH value of the starch liquor without the added sizing agent was 6.9. The optical brightener used was a commercially available product from the group of tetra-sulfonated diamino stilbene derivatives in a very high concentration of 25 g/l. The respective aforementioned products were used in the paste as sizing agents in a concentration of 7 g/l. However, the cationic alkyl ketene dimer emulsion was added to the paste in a concentration of 1.4 g/l. Wet absorption for all papers was 47%. After having been modified with the paste, the paper was dried for 2 minutes at 100° C. in a drum dryer and subsequently post-treated for 10 minutes at 105° C.

The measured COBB values and brightness values are summarized in Table 3:

TABLE 3

| | | ISO brightness |
|---|---|---|
| | Cobb_{60″post-cured} | D65/10° |
| Brightener Neucoblanc PC 110 S = | 10 min/105° C. | R₄₅₇₊ |
| tetrasulfo type | [g/m²] | [%] |
| without brightener | 138 | 79.4 |
| only starch with brightener | 138 | 100.2 |
| 7 g/l mixture of Perglutin K 532 with | 27 | 80.2 |
| AKD at a ratio of 80:20 without | | |
| brightener | | |
| 7 g/l mixture of Perglutin K 532 with | 38 | 100.2 |
| AKD at a ratio of 80:20 with brightener | | |
| 7 g/l Perglutin K 532 without brightener | 59 | 79.9 |
| 7 g/l Perglutin K 532 with brightener | 100 | 98.8 |
| 7 g/l Perglutin A 288 without brightener | 113 | 80.1 |
| 7 g/l Perglutin A 288 with brightener | 108 | 99.1 |
| 1.4 g/l AKD without brightener | 81 | 80.2 |
| 1.4 g/l AKD with brightener | 97 | 98.9 |

The results demonstrate very clearly the outstanding action of the combination according to the invention. Neither the cationic product itself, nor a typical anionic sizing agent, nor the AKD dispersion in concentrations of identical quantities produce even nearly comparably good results.

### EXAMPLE 3

A cationic polymer dispersion, trade name Perglutin K 532, was mixed with a cationic alkyl ketene dimer emulsion at a ratio of 80:20 by stirring. This mixture was compared to the cationic polymer dispersion Perglutin K 532 and the anionic polymer dispersion Perglutin A 288. Unsized raw board having a grammage of 150 g/m², produced from 60% eucalyptus sulfate pulp, 40% pine kraft pulp and 22% precipitated calcium carbonate (PCC), was impregnated in a laboratory size press from the company Einlehner (Prüfmaschinenbau Augsburg) with a starch paste at 32 m/min and 3 bar contact pressure. The paste contained 8% of an enzymatically decomposed corn starch and the viscosity thereof was 22 mPas at 60° C. The pH value of the starch liquor without the added sizing agent was 6.7. The optical brightener used was a commercially available product from the group of tetra-sulfonated diamino stilbene derivatives in a concentration of 10 g/l. The respective aforementioned products were used in the paste in pure form as sizing agents in a concentration of 12 g/l. Wet absorption for all papers was 75%. After having been modified with the paste, the paper was dried for 2 minutes at 100° C. in a drum dryer and subsequently post-treated for 10 minutes at 105° C.

The measured COBB values and brightness values are summarized in Table 4:

TABLE 4

| | | ISO brightness |
|---|---|---|
| | Cobb_{60″post-cured} | D65/10° |
| Brightener Neucoblanc PC 110 S = | 10 min/105° C. | R₄₅₇₊ |
| tetrasulfo type | [g/m²] | [%] |
| without brightener | 136 | 70.3 |
| only starch with brightener | 136 | 86.3 |
| 12 g/l mixture of Perglutin K 532 with | 18 | 72.4 |
| AKD at a ratio of 80:20 without brightener | | |
| 12 g/l mixture of Perglutin K 532 with | 27 | 87.1 |
| AKD at a ratio of 80:20 with brightener | | |
| 12 g/l Perglutin K 532 without brightener | 20 | 72.1 |
| 12 g/l Perglutin K 532 with brightener | 126 | 86.4 |
| 12 g/l Perglutin A 288 without brightener | 34 | 72.2 |
| 12 g/l Perglutin A 288 with brightener | 38 | 87.6 |

The results demonstrate very clearly the outstanding action of the surface sizing agent according to the invention. Neither the cationic product itself nor a typical anionic sizing agent in concentrations of identical quantities produce even nearly comparably good results.

### EXAMPLE 4

A cationic polymer dispersion, trade name Perglutin K 532, was blended with a cationic alkyl ketene dimer emulsion at a ratio of 80:20 by stirring. This mixture was compared to the cationic polymer dispersion Perglutin K 532, the cationic polymer dispersion EKA SP CE 28 (Eka Chemicals), the cationic polymer dispersion Basoplast 270 D (BASF) and the 80:20 mixtures thereof with the cationic alkyl ketene dimer emulsions Basoplast 2030 LC (BASF) and Keydime 28 HS (Eka Chemicals). Unsized raw paper having a grammage of 100 g/m², produced from 100% eucalyptus sulfate pulp and 15% precipitated calcium carbonate (PCC), was impregnated in a laboratory size press from the company Einlehner (Prüfmaschinenbau Augsburg) with a starch paste at 32 m/min and 3 bar contact pressure. The paste contained 7.5% of an enzymatically decomposed corn starch and the viscosity thereof was 33 mPas at 60° C. The pH value of the starch liquor without the added sizing agent was 6.8. The optical brightener used was a commercially available product from the group of hexa-sulfonated diamino stilbene derivatives in a very high concentration of 25 g/l. The respective aforementioned products were used in the paste as sizing agents in a concentration of 7 g/l. Wet absorption was 60%. After having been modified with the paste, the paper was dried for 2 minutes at 100° C. in a drum dryer and subsequently post-treated for 10 minutes at 105° C.

The measured COBB values and brightness values are summarized in Table 5:

TABLE 5

| | | ISO |
|---|---|---|
| | | bright- |
| | | ness |
| | Cobb_{60″post-cured} | D65/10° |
| Brightener Neucoblanc PC PSP = hexasulfo | 10 min/105° C. | R₄₅₇₊ |
| type | [g/m²] | [%] |
| only starch with brightener | 154 | 98.3 |
| 7 g/l mixture of Perglutin K 532 with Keydime | 31 | 80.3 |
| 28 HS at a ratio of 80:20 without brightener | | |
| 7 g/l mixture of Perglutin K 532 with Keydime | 36 | 98.9 |
| 28 HS at a ratio of 80:20 with brightener | | |
| 7 g/l EKA SP CE 28 without brightener | 89 | 80.2 |
| 7 g/l EKA SP CE 28 with brightener | 121 | 98.5 |
| 7 g/l EKA SP CE 28 and Keydime 28 HS at a | 34 | 80.4 |
| ratio of 80:20 without brightener | | |
| 7 g/l EKA SP CE 28 and Keydime 28 HS at a | 46 | 98.6 |
| ratio of 80:20 with brightener | | |
| 7 g/l Perglutin K 532 without brightener | 81 | 80.1 |
| 7 g/l Perglutin K 532 with brightener | 122 | 98.8 |
| 7 g/l Perglutin K 532 and Basoplast 2030 LC at | 32 | 80.6 |
| a ratio of 80:20 without brightener | | |
| 7 g/l Perglutin K 532 and Basoplast 2030 LC at | 37 | 99.0 |
| a ratio of 80:20 with brightener | | |
| 7 g/l Basoplast 270 D without brightener | 92 | 80.4 |
| 7 g/l Basoplast 270 D with brightener | 119 | 98.9 |
| 7 g/l Basoplast 270 D and Keydime 28 HS at a | 34 | 80.3 |
| ratio of 80:20 without brightener | | |
| 7 g/l Basoplast 270 D and Keydime 28 HS at a | 52 | 98.8 |
| ratio of 80:20 with brightener | | |
| 7 g/l Basoplast 270 D and Basoplast 2030 LC | 41 | 80.4 |
| at a ratio of 80:20 without brightener | | |
| 7 g/l Basoplast 270 D and Basoplast 2030 LC | 60 | 99.2 |
| at a ratio of 80:20 with brightener | | |
| 7 g/l Perglutin K 600 without brightener | 76 | 80.4 |
| 7 g/l Perglutin K 600 with brightener | 109 | 98.7 |
| 7 g/l Perglutin K 600 and Keydime 28 HS at a | 37 | 80.3 |
| ratio of 80:20 without brightener | | |
| 7 g/l Perglutin K 600 and Keydime 28 HS at a | 45 | 98.9 |
| ratio of 80:20 with brightener | | |
| 7 g/l Perglutin K 600 and Basoplast 2030 LC at | 44 | 80.0 |
| a ratio of 80:20 without brightener | | |
| 7 g/l Perglutin K 600 and Basoplast 2030 LC at | 60 | 98.6 |
| a ratio of 80:20 with brightener | | |

The comparison demonstrates that the combination with AKD according to the invention allows effective sizing in the presence of anionic brighteners for all systems that were analyzed.

1. A paste for surface sizing paper, comprising starch and at least one anionic optical brightener, wherein a mixture comprising at least one cationic polymer dispersion and at least one cationic and/or amphoteric alkyl ketene dimer dispersion or emulsion is contained as the sizing agent.

2. Paste according to claim 1, wherein the weight ratio of the cationic polymer dispersion(s) to the alkyl ketene dimer dispersion(s) or emulsion(s) ranges from 90:10 to 50:50, preferably from 85:15 to 70:30, and more preferably is approximately 80:20.

3. Paste according to claim 1, wherein the cationic polymer dispersion is an emulsion copolymer comprising hydrophobic ethylenically unsaturated monomers and cationic ethylenically unsaturated monomers.

4. Paste according to claim 1, wherein the cationic polymer dispersion is a styrene acrylate copolymer dispersion, with the copolymer containing di-methylaminopropyl(meth)acrylamide monomers.

5. Paste according to claim 1, wherein the alkyl ketene dimer dispersion or emulsion contains dispersing agents and/or stabilizers.

6. Paste according to claim 1, wherein the brightener is a stilbene derivative carrying sulfonic acid groups.

7. Paste according to claim 1, wherein comprising further common additives, selected from the group consisting of polyvinyl alcohol, electrolytes, dyes and pigments.

8. Method for surface sizing paper, wherein the sizing is carried out using a paste according to claim 1.

9. Method according to claim 8, wherein the paste is applied to the paper web by spraying or by means of a size press or film press or a speed sizer, or online or offline using a coating system.

10. Use of a mixture comprising at least one cationic polymer dispersion and at least one alkyl ketene dimer dispersion or emulsion as a sizing agent for surface sizing paper, wherein the paste contains an anionic optical brightener.

11. Use according to claim 10, wherein the weight ratio of the cationic polymer dispersion(s) to the alkyl ketene dimer dispersion(s) or emulsion(s) ranges from 90:10 to 50:50, preferably from 85:15 to 70:30, and more preferably is approximately 80:20.

12. Use according to claim 10, wherein the cationic polymer dispersion is an emulsion copolymer comprising hydrophobic ethylenically unsaturated monomers and cationic ethylenically unsaturated monomers.

13. Use according to claim 10, wherein the cationic polymer dispersion is a styrene acrylate copolymer dispersion, with the copolymer containing (meth)acrylamide monomers.

14. Use according to claim 13, wherein the (meth)acrylamide monomers are dialkylamino(alkyl)(meth)acrylamide monomers, and more preferably dimethylaminopropyl(meth)acrylamide monomers.

15. Use according to claim 10, wherein the alkyl ketene dimer dispersion or emulsion contains dispersing agents and/or stabilizers.

16. Use according to claim 10, wherein the brightener is a stilbene derivative carrying sulfonic acid groups.
